(19) United States
(12) Patent Application Publication
(10) Pub. No.: US 2026/0225387 A1
(43) Pub. Date: Aug. 6, 2026

(54) LABEL PRINTER

(71) Applicant: Tomoya Nakamura, Sunto Shizuoka (JP)

(72) Inventor: Tomoya Nakamura, Sunto Shizuoka (JP)

(73) Assignee: ETRIA Co., Ltd., Kanagawa (JP)

(21) Appl. No.: 19/443,358

(22) Filed: Jan. 8, 2026

(30) Foreign Application Priority Data
Feb. 3, 2025 (JP) 2025-016369

(51) Int. Cl. B41J 29/393; B41J 2/325; B41J 3/407; B41J 11/00; B41J 11/42; B41J 35/36

(52) U.S. Cl. CPC B41J 29/393; B41J 2/325; B41J 3/4075; B41J 11/0095; B41J 11/42; B41J 35/36

(57) ABSTRACT

A label printer according to an embodiment includes: a transport unit that conveys a label sheet; a ribbon supply unit that supplies an ink ribbon along a transport path; a print head that prints by transferring ink from the ink ribbon onto the label sheet conveyed to a printing position; an acquisition unit that acquires a request signal requesting feeding of the label sheet to the printing position; a determination unit that detects an operating state of the ribbon supply unit driven in response to the request signal and determines whether the ink ribbon is present or absent, based on a detection result; and an output unit that, in a case where the determination unit determines that the ink ribbon is absent, outputs a stop signal to stop the ribbon supply unit and a drive signal to drive the transport unit to feed the label sheet to the printing position.

### CROSS-REFERENCE TO RELATED APPLICATIONS

This application is based upon and claims the benefit of priority from Japanese Patent Application No.2025-016369, filed Feb. 3, 2025, the entire contents of which are incorporated herein by reference.

### FIELD

Embodiments described herein generally relate to label printers that print images such as barcodes on an elongated label sheet.

### BACKGROUND

For example, a label printer conveys a label sheet in which a plurality of labels are affixed to an elongated base sheet, and prints an image such as a barcode on each label. For example, the label printer feeds an ink ribbon along the label sheet and transfers ink to each label using a thermal head.

The label printer includes a feed key for aligning each label with the thermal head. When the operator presses the feed key, the label printer detects whether the ink ribbon is present or absent, and if present, feeds the label sheet to the printing position.

To determine whether the ink ribbon is present or absent, the label printer rotates a ribbon motor that supplies the ink ribbon, detects its rotation speed, and determines the presence or absence of the ink ribbon, based on the detection result. To be more specific, the label printer determines that the ink ribbon is present when the ribbon motor rotates at a normal speed, and determines that the ink ribbon is absent when the ribbon motor rotates at a speed higher than normal.

In the conventional label printer described above, if the ribbon motor is rotated after the feed key is pressed and the absence of the ink ribbon is detected, a ribbon error is generated. The ribbon motor is then stopped, and the process is terminated without feeding the label sheet. Therefore, in conventional label printers, if no ink ribbon is installed, the label sheet cannot be fed, even when the feed operation does not depend on the presence of the ink ribbon.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an external perspective view of a label printer according to an embodiment.

FIG. 2 is a schematic cross-sectional view showing the internal structure of the label printer of FIG. 1.

FIG. 3 is a block diagram of the control system of the label printer of FIG. 1.

FIG. 4 is a flowchart illustrating an example of the operation of the label printer of FIG. 1.

### DETAILED DESCRIPTION

A label printer according to an embodiment includes: a transport unit that conveys an elongated label sheet; a ribbon supply unit that supplies an ink ribbon along the transport path of the label sheet; a print head that prints by transferring ink from the ink ribbon onto the label sheet conveyed to a printing position; an acquisition unit that acquires a request signal requesting feeding of the label sheet to the printing position; a determination unit that detects an operating state of the ribbon supply unit driven in response to the request signal and determines whether the ink ribbon is present or absent; and an output unit that, in the case where the determination unit determines that the ink ribbon is absent, outputs a stop signal to stop the ribbon supply unit and a drive signal to drive the transport unit to feed the label sheet to the printing position.

The label printer 10 according to the embodiment will now be described with reference to the drawings.

As shown in FIG. 1, the label printer 10 includes a substantially rectangular block-shaped housing forming the outer shell of the apparatus. The housing includes a left housing 11 and a right housing 12 as viewed from the operation side. The right housing 12 is wider than the left housing 11 in the lateral direction. The two housings 11 and 12 are combined such that their openings face each other. The opposing edge portions of the top plates of the two housings 11 and 12 are coupled by two hinges 13. Accordingly, by rotating the right housing 12 upward about the hinges 13, the interior of the housings 11 and 12 can be widely opened.

The front panel 14 of the left housing 11 is provided with a power switch 15, a display unit 16, and an operation unit 17. The operation unit 17 includes a plurality of operation buttons 18. The plurality of operation buttons 18 include a feed key 1. The front panel 19 of the right housing 12 includes a label issuing slot 20 from which printed labels are discharged. In the present embodiment and in the claims, the term “printing” includes not only printing of images such as patterns and barcodes but also printing of character information.

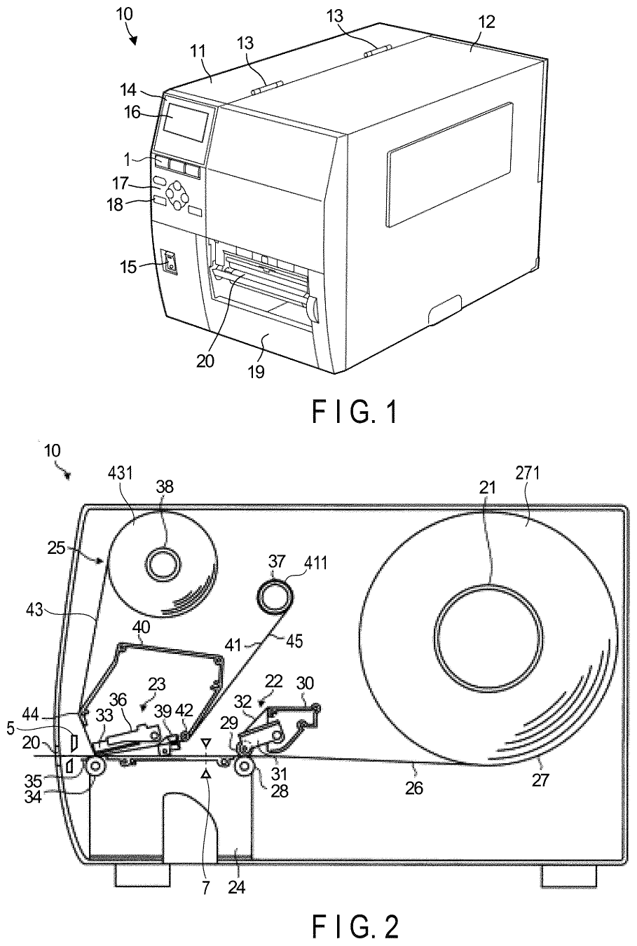

As shown in FIG. 2, the label printer 10 includes, inside the housings 11 and 12, a holding unit 21 that holds a label roll 271, a transport unit 22 that conveys a label sheet 27, a printing unit 23 that prints an image on a label, and a ribbon supply unit 25. By rotating the right housing 12 about the hinges 13 to open the internal space, operations, such as attaching the label roll 271 to the holding unit 21, replacing ribbon rolls 411 and 431 in the ribbon supply unit 25, or performing maintenance on the respective mechanisms 21, 22, 23 and 25 of the label printer 10, can be performed.

The holding unit 21 rotatably holds the label roll 271 in which an elongated belt-shaped label sheet 27 is wound into a roll. The holding unit 21 includes a shaft extending in a direction perpendicular to the plane of FIG. 2. The holding unit 21 has a structure that allows mounting and removal of the label roll 271. When the label sheet 27 is pulled out leftward in FIG. 2, the label roll 271 rotates clockwise about the holding unit 21.

As the label sheet 27, for example, a label peel type sheet may be used, in which a plurality of labels are affixed in series on the surface of an elongated base sheet; alternatively, a linerless type label sheet may be used, in which a plurality of labels are coupled in a strip without using the base sheet. The linerless type label sheet 27 includes an adhesive layer on its back surface and a release layer on its front surface, and the release layer can be peeled from the adhesive layer. The labels may be made of a non-thermosensitive material, on which images are printed by transferring ink from an ink ribbon 41 by heat, or of a thermosensitive material, which develops color upon heating.

In other words, the label roll 271 may be either a non-thermosensitive type label roll 271 or a thermosensitive type label roll 271. The non-thermosensitive label roll 271 is formed by winding either a label-peel type sheet 27 (first label sheet), in which a plurality of non-thermosensitive labels are affixed to an elongated base sheet, or a linerless type label sheet 27 (first label sheet), in which a plurality of non-thermosensitive labels are connected in a continuous strip without a base sheet. Similarly, the thermosensitive label roll 271 is formed by winding either a label-peel type sheet 27 (second label sheet), in which a plurality of thermosensitive labels are affixed to an elongated base sheet, or a linerless type label sheet 27 (second label sheet), in which a plurality of thermosensitive labels are connected in a continuous strip without a base sheet.

The transport unit 22 includes a transport roller 28, a pinch roller 29, frames 24 and 30, a support arm 31, a leaf spring 32, and a label sensor 7.

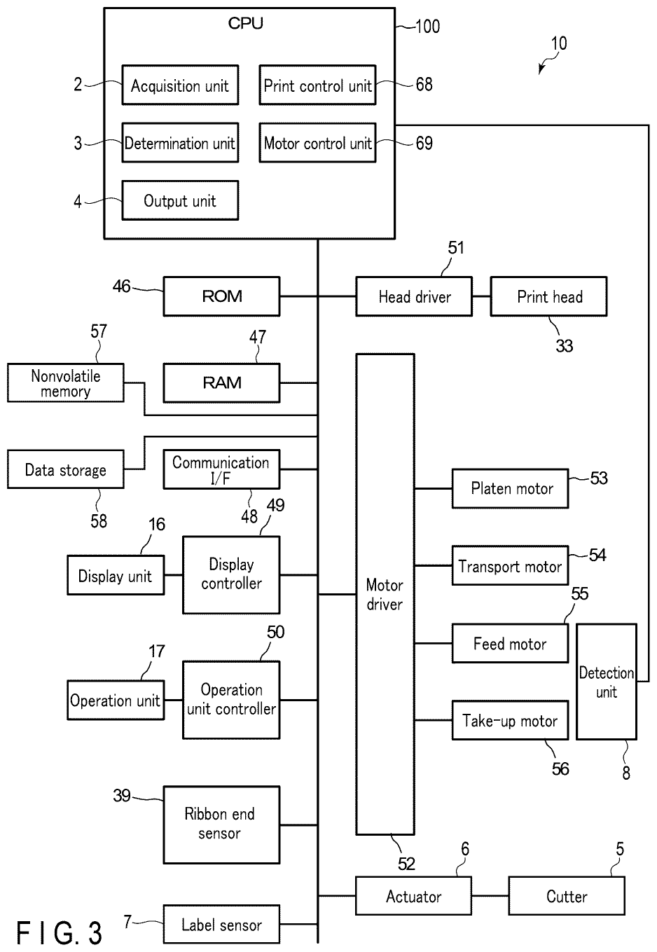

The transport roller 28 has a rotational axis extending in a direction perpendicular to the plane of FIG. 2. The transport unit 22 defines a transport path 26 along which the label sheet 27 drawn out from the label roll 271 is conveyed substantially horizontally. The frame 24 is located below the transport path 26. The frame 24 rotatably supports the transport roller 28 below the transport path 26. The label printer 10 includes a transport motor 54 (FIG. 3) that rotates the transport roller 28.

The pinch roller 29 has a rotational axis extending in a direction perpendicular to the plane of FIG. 2. The pinch roller 29 is positioned above the transport path 26 so as to face the transport roller 28. The support arm 31 has the pinch roller 29 rotatably attached to its rotating distal end. The frame 30 is located above the transport path 26. The frame 30 rotatably supports the base end portion of the support arm 31. The leaf spring 32 is installed between the frame 30 and the support arm 31, and applies a restoring force in a direction that presses the pinch roller 29 against the transport roller 28.

The label sensor 7 is, for example, a transmission-type sensor including a light-emitting portion and a light-receiving portion, which are disposed with the transport path 26 of the label sheet 27 interposed therebetween. The label sensor 7 is on the transport path 26 located between the transport unit 22 and the printing unit 23. The label sensor 7 detects light transmitted through the label sheet 27 and outputs a signal reflecting an increase or decrease in the amount of transmitted light associated with the transportation of the label sheet 27. More specifically, the label sensor 7 emits light from the light-emitting portion toward the label sheet 27, receives the light transmitted through the label sheet 27 at the light-receiving portion, and outputs an electrical signal that varies according to the amount of received light (transmitted light).

When the transport roller 28 is rotated by the transport motor 54, the label sheet 27, which is pinched between the transport roller 28 and the pinch roller 29, is conveyed along the transport path 26 by the transport force from the transport roller 28, and is drawn from the label roll 271. At this time, the label printer 10 detects the leading or trailing end of each label in the transport direction, based on a signal output from the label sensor 7. Based on this detection result, the transport motor 54 is rotated and stopped, thereby allowing the label to be conveyed (fed) to the printing position.

The transport path 26 of the label sheet 27 starts at the portion where the label sheet 27 is drawn from the label roll 271 mounted on the holding unit 21. The transport path 26 passes through the position where the pinch roller 29 and the transport roller 28 are in contact with each other in the transport unit 22. The transport path 26 passes through the position where the print head 33 of the printing unit 23 and the platen roller 34 are in contact with each other. Located at the end of the transport path 26 is a label discharge port 20. When a peel-off type label sheet, in which a plurality of labels are affixed to the base sheet, is used, only labels peeled off from the base sheet can be discharged from the label discharge port 20.

The printing unit 23 includes a print head 33, a platen roller 34, and a holding arm 36.

The platen roller 34 includes a rotational shaft extending in a direction perpendicular to the plane of the sheet in FIG. 2. The frame 24 of the transport unit 22, located below the transport path 26, rotatably supports the platen roller 34 below the transport path 26. The label printer 10 includes a platen motor 53 (FIG. 3) for rotating the platen roller 34. The platen roller 34 and the platen motor 53 function as part of the transport unit 22 that conveys the label sheet 27.

The print head 33 is positioned above the platen roller 34 so as to face it across the transport path 26. The print head 33 is, for example, a thermal head including a plurality of heating elements arranged in a direction perpendicular to the plane of the sheet in FIG. 2. The ink ribbon 41 and the label sheet 27 pass through the transport path 26 between the platen roller 34 and the print head 33 in a superimposed state.

The holding arm 36 is positioned above the transport path 26 and includes the print head 33 at the distal end of its swinging holding arm 36. The frame 40 of the ribbon supply unit 25, which is disposed above the transport path 26, rotatably supports the base end of the swinging holding arm 36. When the holding arm 36 is swung relative to the frame 40, the print head 33 can be separated from the platen roller 34.

The ribbon supply unit 25 is located above the transport path 26. The ribbon supply unit 25 includes a feed-out shaft 37, a take-up shaft 38, a ribbon end sensor 39, and a frame 40.

The feed-out shaft 37 is a shaft extending in a direction perpendicular to the plane of the sheet in FIG. 2, and removably holds a ribbon roll 411 on which an unused ink ribbon 41 is wound in a roll form. When the feed-out shaft 37 is rotated clockwise in FIG. 2, the ink ribbon 41 is fed from the ribbon roll 411.

The frame 40 includes a guide roller 42 that winds and guides the ink ribbon 41 fed from the ribbon roll 411. The guide roller 42 includes a rotational shaft extending in a direction perpendicular to the plane of the sheet in FIG. 2 and mounted on the frame 40 so as to be freely rotatable.

The take-up shaft 38 is a shaft extending in a direction perpendicular to the plane of the sheet in FIG. 2, and removably holds a ribbon roll 431 on which the used ink ribbon 43, having passed through the print head 33, is wound in a roll form. When winding the used ink ribbon 43, the take-up shaft 38 is rotated clockwise in FIG. 2.

Between the print head 33 and the take-up shaft 38, a guide roller 44 is provided for winding and guiding the used ink ribbon 43. The guide roller 44 includes a rotational shaft extending in a direction perpendicular to the plane of the sheet in FIG. 2 and mounted on the frame 40 so as to be freely rotatable.

The label printer 10 includes a feed motor 55 (FIG. 3) for rotating the feed-out shaft 37 and a take-up motor 56 (FIG. 3) for rotating the take-up shaft 38. By driving the feed motor 55 and the take-up motor 56, the ribbon supply unit 25 supplies the ink ribbon 41 along the transport path 26 of the label sheet 27 and winds the used ink ribbon 43. The ink ribbon 41 passes between the platen roller 34 and the print head 33 in a superimposed state on the label sheet 27.

The transport path 45 of the ink ribbons 41 and 43 starts at the position where the ink ribbon 41 is fed from the ribbon roll 411 mounted on the feed-out shaft 37. The transport path 45 passes through a position which is in contact with the guide roller 42, and through the ribbon end sensor 39 and the print head 33. Then, the transport path 45 passes through the guide roller 44 and ends at the portion where the used ink ribbon 43 is wound by the take-up shaft 38.

The ribbon end sensor 39 detects the end of the ink ribbon 41. The ribbon end sensor 39 is located between the feed-out shaft 37, which feeds the ink ribbon 41, and the printing unit 23. The ribbon end sensor 39 is, for example, a reflective sensor including a light-emitting element and a light-receiving element. Alternatively, the ribbon end sensor 39 may be a transmissive sensor, or a sensor that mechanically detects the end of the ink ribbon 41.

The label printer 10 further includes a label peeling plate 35 positioned adjacent to the transport path 26 on the downstream side of the printing unit 23. In the case where a peel-off type label sheet is used in which a plurality of labels are affixed to a base sheet, the labels are peeled from the base sheet by the label peeling plate 35. The base sheet from which the labels have been peeled can be wound by a take-up mechanism (not shown). In this case, the label sheet 27 is bent by being wound around the platen roller 34, and the labels are peeled from the base sheet by the label peeling plate 35 disposed on the outer side of the bending position. After being peeled from the base sheet, the labels are discharged from the label discharge port 20.

The label printer 10 also includes a cutter 5 located on the upstream side of the label discharge port 20 and configured to cut the elongated linerless-type label sheet 27 between adjacent labels. When a linerless-type label sheet 27, in which a plurality of labels are continuously connected in a band without a base sheet, is used, the label sheet 27 is cut by the cutter 5 immediately before the label discharge port 20. Each label that has been cut into a single piece by the cutter 5 is delivered through the label issuing port 20.

In the above-described label printer 10, in the case where a non-thermosensitive-type label roll 271 is mounted on the holding unit 21 and the ink transfer printing mode is executed, the transport unit 22 draws the label sheet 27 from the label roll 271 and conveys it along the transport path 26, the ribbon supply unit 25 supplies the ink ribbon 41 over the label sheet 27, the print head 33 transfers ink from the ink ribbon 41 onto the label to be printed on the label sheet 27, and an intended image is printed on each label of the label sheet 27.

In the above-described label printer 10, in the case where a thermal-developing-type label roll 271 is mounted on the holding unit 21 and the thermosensitive print mode is executed, the transport unit 22 draws the label sheet 27 from the label roll 271 and conveys it along the transport path 26, the print head 33 develops color in the thermosensitive layer of the label to be printed, and an intended image is printed on each label of the label sheet 27.

Next, a description will be given of a control system that controls the operation of the label printer 10.

As shown in FIG. 3, the label printer 10 includes a CPU (Central Processing Unit) 100, a ROM (Read Only Memory) 46, a RAM (Random Access Memory) 47, a nonvolatile memory 57, and a data storage 58. The CPU 100 is coupled, via a bus or an interface, to the ROM 46, the RAM 47, the nonvolatile memory 57, and the data storage 58, as well as to a communication interface 48, a display controller 49, an operation unit controller 50, a head driver 51, a motor driver 52, the label sensor 7, the ribbon end sensor 39, an actuator 6, and a detection unit 8. It should be noted that in FIG. 3, the term “interface” is abbreviated as “I/F.”

The ROM 46 stores programs and various types of data executed by the label printer 10. The RAM 47 is a memory used by the CPU 100 as a temporary storage area for programs and data when the above-described programs are executed. The nonvolatile memory 57 stores operation histories and the like. The data storage 58 stores print data and the like. The communication interface 48 couples the label printer 10 to a host computer (not shown) and controls data communication between the label printer 10 and the host computer. For example, the host computer transmits print data (or print commands) to the data storage 58 via the communication interface 48. Alternatively, the print data may be input via the operation unit 17. Examples of the communication interface 48 include USB, RS-232C, and LAN.

The display unit 16 is coupled to the display controller 49. The operation unit 17 is coupled to the operation unit controller 50. The print head 33 is coupled to the head driver 51. The head driver 51 controls the on/off energization of heating elements of the print head 33 based on print data, thereby thermally transferring a print image (graphic) onto each label of the label sheet 27. The actuator 6 drives the cutter 5.

The motor driver 52 is coupled to the platen motor 53, the transport motor 54, the feed motor 55, and the take-up motor 56. The platen motor 53 rotationally drives the platen roller 34 of the printing unit 23. The transport motor 54 rotationally drives the transport roller 28 of the transport unit 22. The feed motor 55 rotationally drives the feed-out shaft 37 of the ribbon supply unit 25. The take-up motor 56 rotationally drives the take-up shaft 38 of the ribbon supply unit 25. In the description below, the feed motor 55 and the take-up motor 56 may collectively be referred to as ribbon motors 55 and 56.

The detection unit 8 includes, for example, light-shielding plates respectively attached to rotation shafts of the ribbon motors 55 and 56, a light-emitting portion that emits light rays passing through light-transmission holes formed in the light-shielding plates, and a light-receiving portion that receives the light rays that have passed through the light-transmission holes. The detection unit 8 receives light passing through the light-transmitting holes of the rotating shutter plate, and detects the rotational speeds of the ribbon motors 55 and 56 based on the number of times the light rays are received by the light-receiving unit per unit time.

The program executed by the label printer 10 is pre-stored in the ROM 46 or the like and provided as a built-in program. The program executed by the label printer 10 according to the present embodiment may be configured to be provided as a file in an installable or executable format recorded on a computer-readable storage medium, such as a CD-ROM, flexible disk (FD), CD-R, or DVD (Digital Versatile Disk). Furthermore, the program executed by the label printer 10 according to the present embodiment may be stored on a computer connected to a network such as the Internet and provided by downloading via the network. Alternatively, the program executed by the label printer 10 according to the present embodiment may be provided or distributed via a network such as the Internet.

As shown in in FIG. 3, the CPU 100 (processor) includes modules such as an acquisition unit 2, a determination unit 3, an output unit 4, a print control unit 68, and a motor control unit 69. The CPU 100 loads a program stored in a storage medium such as a ROM 46 onto a main storage device (e.g., a RAM 47), and executes the program to realize the functions of the acquisition unit 2, determination unit 3, output unit 4, print control unit 68, motor control unit 69, and other components. The functions of each of the components 2, 3, 4, 68 and 69 of the CPU 100 will be described below.

The acquisition unit 2 acquires a request signal that requests feeding of the label sheet 27. Since the label sheet 27 includes a plurality of labels arranged in the longitudinal direction, the label to be printed has to be correctly aligned with the printing position, for example, after the print head 33 has been separated from or brought into contact with the platen roller 34, or after a transport error of the label sheet 27 has been processed. The transport operation of the label sheet 27 for aligning the label to be printed with the printing position will be referred to as “feed.”

When an operator operates the feed key 1, the acquisition unit 2 receives this as a request signal for feeding the label sheet 27. The acquisition unit 2 also receives a command from a host computer requesting a feed, and treats it as a request signal for feeding the label sheet 27.

The determination unit 3 first detects the driving state of the ribbon supply unit 25 that is driven in response to the request signal acquired by the acquisition unit 2. Then, based on the detection result, the determination unit 3 determines whether an ink ribbon 41 is present or absent. The term “driving state of the ribbon supply unit 25” as used herein refers, for example, to the number of rotations per unit time of the feed motor 55 and/or the number of rotations per unit time of the take-up motor 56.

In the case where the detected numbers of rotations of the ribbon motors 55 and 56 correspond to the normal rotational speed during supply of the ink ribbon 41, the determination unit 3 determines that the ribbon is present. In the case where a relatively high rotational speed indicating idling of the ribbon motors 55 and 56 in the absence of the ink ribbon is detected, the determination unit 3 determines that the ribbon is absent. Specifically, in the case where the detected rotational speed of the ribbon motors 55 and 56 is equal to or lower than a predetermined threshold value, the determination unit 3 determines that the ink ribbon is present, and in the case where the detected rotational speed exceeds the threshold value, the determination unit 3 determines that the ink ribbon is absent.

In the case where the feed key 1 is operated by an operator to drive the feed motor 55 and the take-up motor 56, and the determination unit 3 determines that the ink ribbon is absent, the output unit 4 outputs a stop signal for stopping the feed motor 55 and the take-up motor 56, and a drive signal for feeding the label sheet 27 to the printing position. Further, in the case where the feed key 1 is operated by the operator to drive the feed motor 55 and the take-up motor 56, and the determination unit 3 determines that the ink ribbon is present, the output unit 4 outputs a drive signal for feeding the label sheet 27 to the printing position without outputting a stop signal for stopping the feed motor 55 and the take-up motor 56.

For example, in response to an input of an ink transfer print mode accepted through the operation unit 17, and when print data is input via the communication interface 48 or the operation unit controller 50, the print control unit 68 controls the operation of the print head 33 via the head driver 51. The print control unit 68 prints an image based on the print data by transferring the ink of the ink ribbon 41 onto the label sheet 27 drawn out from the loaded non-thermosensitive type label roll 271.

Further, in response to an input of a thermosensitive print mode accepted through the operation unit 17, and when print data is input via the communication interface 48 or the operation unit controller 50, the print control unit 68 controls the operation of the print head 33 via the head driver 51, and prints an image based on the print data by causing a thermal color-developing layer of the label sheet 27, which is drawn out from the loaded thermal color-developing type label roll 271, to develop color.

The motor control unit 69 controls, via the motor driver 52, the rotational driving of the platen motor 53, transport motor 54, feed motor 55, and take-up motor 56 required for transferring print data onto the label sheet 27.

Among the various functions realized by the CPU 100 through execution of a program, part of these functions may alternatively be implemented by hardware circuits, such as an ASIC (Application Specific Integrated Circuit), DSP (Digital Signal Processor), FPGA (Field-Programmable Gate Array), or GPU (Graphics Processing Unit). In such a case, the CPU 100 controls the functions executed by the hardware circuits.

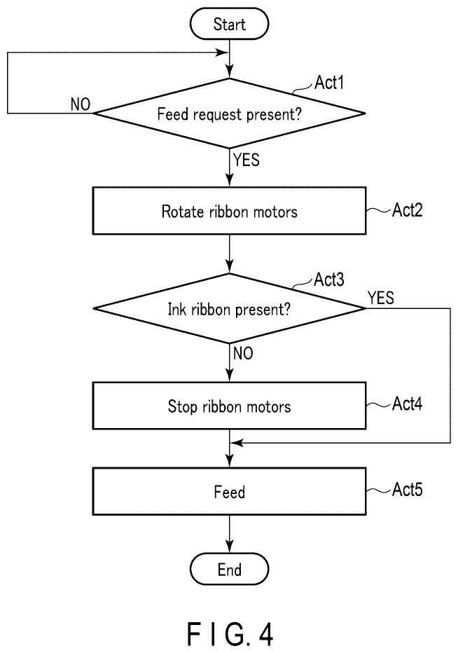

Next, an example of the operation of the above-described label printer 10 will be described with reference to FIG. 4.

For example, when the feed key 1 is pressed by the operator, the operation unit controller 50 outputs a request signal for feeding the label sheet 27 to the printing position in response to the pressing of the feed key 1. When the acquisition unit 2 acquires this request signal (Act 1; YES), the label printer 10 proceeds to Act 2, in which the motor driver 52 is controlled to rotationally drive the feed motor 55 and the take-up motor 56 of the ribbon supply unit 25. Regardless of the contents recorded in the operation history, the motor driver 52 rotationally drives the feed motor 55 and the take-up motor 56 of the ribbon supply unit 25 to detect the presence or absence of the ink ribbon 41. For example, the operation history includes information such as a printing date and time, a printing mode type, and the number of printed sheets. It is sufficient that the operation history includes at least the immediately preceding printing operation history. The immediately preceding printing operation history indicates whether the immediately preceding printing mode was the ink transfer printing mode or the thermosensitive print mode.

After the ribbon motors 55 and 56 are rotationally driven in Act 2, the determination unit 3 detects the rotational speeds of the ribbon motors 55 and 56 via the detection unit 8, and determines, based on the detection result, whether the ink ribbon 41 is present or absent (Act 3). At this time, in Act 3, if the detected rotational speed is equal to or smaller than a predetermined threshold value, the determination unit 3 determines that the ink ribbon is present, and if the detected rotational speed exceeds the threshold value, the determination unit 3 determines that the ink ribbon is absent.

When the determination unit 3 determines, in Act 3, that the ink ribbon is absent (Act 3; NO), the output unit 4 outputs a stop signal for stopping the ribbon motors 55 and 56 of the ribbon supply unit 25, and also outputs a drive signal for feeding the label sheet 27 to the printing position. The label printer 10 then controls the motor driver 52 based on the stop signal and the drive signal output by the output unit 4, such that the ribbon motors 55 and 56 are stopped (Act 4) and the platen motor 53 and the transport motor 54 are rotationally driven to feed the label sheet 27 to the printing position (Act 5). In addition, the CPU 100 updates the operation history stored in the nonvolatile memory 57 in accordance with the determination of the absence of the ink ribbon and the feeding of the label sheet 27, and records the thermosensitive print mode as the immediately preceding operation history.

On the other hand, when the determination unit 3 determines, in Act 3, that the ink ribbon is present (Act 3; YES), the output unit 4 outputs a drive signal for rotationally driving the platen motor 53 and the transport motor 54 without outputting a stop signal for stopping the ribbon motors 55 and 56. The label printer 10 then controls the motor driver 52, based on the drive signal output by the output unit 4, such that the platen motor 53 and the transport motor 54 are rotationally driven to feed the label sheet 27 to the printing position (Act 5).

According to the above-described example of operation, even if the feed key 1 is pressed in a state where the ribbon rolls 411 and 431 are not attached, the label sheet 27 can be fed to the printing position without causing a ribbon-missing error. That is, according to the above-described example of operation, when feeding that is not related to the presence or absence of the ink ribbon 41 is performed, processing can continue without generating unnecessary errors such as a ribbon error.

Next, an operation according to a printing mode will be described.

When the feeding in Act 5 shown in FIG. 4 has been completed, and when the non-thermosensitive type label roll 271 and the ribbon rolls 411 and 431 are loaded in the label printer 10 and preparation for ink transfer printing has been completed, the operation unit 17 accepts an input of the ink transfer printing mode and print execution, and the operation unit controller 50 specifies the ink transfer printing mode and the print execution. Based on the specified ink transfer printing mode, the output unit 4 outputs a drive signal for driving the platen motor 53, transport motor 54, feed motor 55, and take-up motor 56, thereby rotating the platen motor 53, transport motor 54, feed motor 55 and take-up motor 56. The ribbon supply unit 25 supplies the ink ribbon 41 drawn out from the ribbon roll 411 to the printing position, and the transport unit 22 conveys the label sheet 27 drawn out from the label roll 271 through the printing position. In accordance with the specified ink transfer printing mode, the print head 33 transfers the ink of the ink ribbon 41 onto each label of the non-thermosensitive type label sheet 27 to print an image based on the print data.

The output unit 4 outputs a signal for updating the operation history stored in the nonvolatile memory 57 in accordance with the printing operation performed in the ink transfer printing mode. In response to this update signal, the CPU 100 updates the printing mode of the immediately preceding operation history to the ink transfer printing mode.

Alternatively, when the feeding in Act 5 has been completed, and in the case where the thermal-type label roll 271 is loaded in the label printer 10 and preparation for thermal color-developing printing has been completed, the operation unit controller 50 specifies the thermosensitive print mode and the print execution when the operation unit 17 accepts inputs of the thermosensitive print mode and print execution. Based on the specified thermosensitive print mode, the output unit 4 outputs a drive signal for driving the platen motor 53 and the transport motor 54, thereby rotating the platen motor 53 and the transport motor 54. Since the feed motor 55 and the take-up motor 56 are not rotated, the ink ribbon 43 is not supplied. The transport unit 22 conveys the label sheet 27 pulled out from the label roll 271 through the printing position. The print head 33 thermally colors each label on the thermal coloring label sheet 27 in accordance with the specified thermosensitive print mode, thereby printing an image based on the print data.

The output unit 4 outputs a signal to update the operation history stored in the nonvolatile memory 57, in accordance with the printing operation in the thermosensitive print mode. The CPU 100 updates the print mode of the immediately preceding operation history to the thermosensitive print mode, in response to this update signal.

Furthermore, after the feeding in Act 5 is completed, if the operation unit 17 accepts a print execution input without a print mode input, the operation unit controller 50 executes printing without specifying a print mode. In this case, the output unit 4 outputs a drive signal according to the print mode indicated in the immediately preceding printing operation history stored in nonvolatile memory 57.

If the print mode indicated by the immediately preceding printing operation history is the ink transfer print mode, the output unit 4 outputs drive signals to drive the platen motor 53, the transport motor 54, the feed motor 55, and the take-up motor 56 in accordance with the ink transfer print mode. Similarly, the print head 33 transfers ink from the ink ribbon 41 to each label on the label sheet 27 according to the ink transfer print mode indicated by the immediately preceding printing operation history, thereby printing an image based on the print data. The CPU 100 updates the operation history stored in nonvolatile memory 57 according to the printing operation in the ink transfer print mode.

If the print mode indicated by the immediately preceding printing operation history is the thermosensitive print mode, the output unit 4 outputs drive signals to drive the platen motor 53 and transport motor 54 in accordance with the thermosensitive print mode. Similarly, the print head 33 thermally colors each label on the thermal coloring label sheet 27 in accordance with the thermosensitive print mode indicated by the immediately preceding printing operation history, thereby printing an image based on the print data. The CPU 100 updates the operation history stored in nonvolatile memory 57 in accordance with printing operations in the thermosensitive print mode.

In this manner, in the case where a print mode is not specified via the operation unit 17, the CPU 100 specifies a print mode based on the immediately preceding operation history and outputs a drive signal corresponding to the specified print mode. This allows the operator to perform printing in the same print mode as the last time, without having to specify a print mode via the operation unit 17 each time.

Furthermore, as shown in FIG. 4, when a feed request is received, the CPU 100 executes the feed operation regardless of the operation history. This rotationally drives the feed motor 55 and take-up motor 56 and checks for the presence or absence of the ink ribbon 41. Whether the ink ribbon 41 is present or absent, the feed operation can be completed without causing an operational error midway.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label printer comprising:
a transport unit that conveys an elongated label sheet;
a ribbon supply unit that supplies an ink ribbon along a transport path of the label sheet;
a print head that prints an image by transferring ink from the ink ribbon onto the label sheet conveyed to a printing position;
an acquisition unit that acquires a request signal to request feeding of the label sheet to the printing position;
a determination unit that detects a drive status of the ribbon supply unit, which is driven in response to the request signal, and that determines whether the ink ribbon is present or absent; and
an output unit that, in a case where the determination unit determines that the ink ribbon is absent, outputs a stop signal to stop the ribbon supply unit and a drive signal to drive the transport unit to feed the label sheet to the printing position.

2. The label printer according to claim 1, wherein the output unit outputs the drive signal without outputting the stop signal in a case where the determination unit determines that the ink ribbon is present.

3. The label printer according to claim 1, wherein the determination unit detects a rotational speed per unit time of a ribbon motor that supplies the ink ribbon, and determines that the ink ribbon is absent in a case where the detected rotational speed exceeds a predetermined threshold that is higher than the rotational speed when the ink ribbon is being supplied.

4. The label printer according to claim 2, wherein the print head is a thermal head that, in accordance with an ink transfer print mode, transfers ink from the ink ribbon onto a first label sheet of a non-thermosensitive type being conveyed to print an image, and, in accordance with a thermosensitive print mode, thermally colors a second label sheet of a thermosensitive coloring type being conveyed to print an image.

5. The label printer according to claim 1, further comprising:
a feed key for requesting the feeding,
wherein the acquisition unit acquires input of the feed key as the request signal.

6. The label printer according to claim 1, further comprising
an interface for transmitting and receiving signals to and from an external device,
wherein the acquisition unit acquires, as the request signal, a command requesting the feeding and transmitted from the external device via the interface.

7. The label printer according to claim 4, wherein the output unit outputs an update signal for updating a print mode recorded in an operation history to the ink transfer print mode in accordance with a printing operation performed in the ink transfer print mode.

8. The label printer according to claim 4, wherein the output unit outputs an update signal for updating a print mode recorded in an operation history to the thermosensitive print mode in accordance with a printing operation performed in the thermosensitive print mode.

9. The label printer according to claim 4, wherein
in a case where the output unit does not accept a print mode input but accepts a print execution input, the output unit outputs the drive signal in accordance with a print mode recorded in an operation history based on an immediately preceding printing operation.

10. A printer control apparatus comprising:
an acquisition unit that acquires a request signal to request feeding of an elongated label sheet to a printing position;
a determination unit that detects a drive status of a ribbon supply unit that supplies an ink ribbon to the printing position in response to the request signal and determines whether the ink ribbon is present or absent; and
an output unit that, in a case where the determination unit determines that the ink ribbon is absent, outputs a stop signal to stop the ribbon supply unit and a drive signal to feed the label sheet to the printing position.

11. The printer control apparatus according to claim 10, wherein the output unit outputs the drive signal without outputting the stop signal when the determination unit determines that the ink ribbon is present.

12. The printer control apparatus according to claim 11, wherein the printer is controlled such that, in accordance with an ink transfer print mode, a first label sheet of a non-thermosensitive type is conveyed, and an image is printed by transferring ink from the ink ribbon onto the first label sheet, and, in accordance with a thermosensitive print mode, a second label sheet of a thermal coloring type is conveyed, and an image is printed by thermally coloring the second label sheet.

13. The printer control apparatus according to claim 10, wherein the acquisition unit acquires the request signal when a feed key of a printer is pressed.

14. The printer control apparatus according to claim 10, wherein the acquisition unit acquires the request signal upon receipt of a command requesting feeding from an external device.

15. The printer control apparatus according to claim 10, wherein the determination unit detects a rotational speed per unit time of a ribbon motor that supplies the ink ribbon, and determines that the ink ribbon is absent when the detected rotational speed exceeds a predetermined threshold that is higher than the rotational speed when the ink ribbon is being supplied.

16. The printer control apparatus according to claim 12, wherein the output unit outputs an update signal for updating a print mode recorded in an operation history, in accordance with a printing operation performed in an ink transfer printing mode.

17. The printer control apparatus according to claim 12, wherein the output unit outputs an update signal to update a print mode recorded an operation history to the thermosensitive print mode in accordance with a printing operation performed in the thermosensitive print mode.

18. The printer control apparatus according to claim 12, wherein
in a case where the output unit does not accept a print mode input but accepts a print execution input, the output unit outputs a drive signal in accordance with a print mode recorded in an operation history based on an immediately preceding printing operation.
